(19) United States
(12) Patent Application Publication
(10) Pub. No.: US 2012/0013430 A1
(43) Pub. Date: Jan. 19, 2012

(54) MANUFACTURING METHOD OF GRAIN ORIENTED ELECTRICAL STEEL SHEET, GRAIN ORIENTED ELECTRICAL STEEL SHEET FOR WOUND CORE, AND WOUND CORE

(76) Inventors: Nobusato Morishige, Tokyo (JP); Kenichi Murakami, Tokyo (JP); Hotaka Honma, Tokyo (JP); Yuji Kubo, Tokyo (JP); Kazumi Mizukami, Tokyo (JP); Koki Tanaka, Tokyo (JP); Seiki Takebayashi, Tokyo (JP)

(21) Appl. No.: 13/257,699

(22) PCT Filed: Mar. 19, 2010
(86) PCT No.: PCT/JP2010/054846

§ 371 Date: Sep. 20, 2011

(30) Foreign Application Priority Data
Mar. 23, 2009 (JP) 2009-070336

(51) Int. Cl. H01F 27/25; C23C 8/00; C22C 38/02; C21D 8/02

(52) U.S. Cl. 336/213; 148/603; 148/208; 420/117

(57) ABSTRACT

A slab having a predetermined composition is heated to 1280° C. or more. The slab is hot-rolled to obtain a hot-rolled steel sheet. The hot-rolled steel sheet is annealed to obtain an annealed steel sheet. The annealed steel sheet is cold-rolled to obtain a cold-rolled steel sheet. The cold-rolled steel sheet is decarburization annealed to obtain a decarburization annealed steel sheet. The decarburization annealed steel sheet is coiled in a coil state. The coil-state decarburization annealed steel sheet is finish-annealed. The cold-rolled steel sheet is heated to a temperature of 800° C. or more at a rate of 30° C./sec or more and 100° C./sec or less during increasing temperature of the cold-rolled steel sheet in the decarburization annealing or before the decarburization annealing. The decarburization annealed steel sheet is heated at a rate of 20° C./h or less within a temperature range of 750° C. or more and 1150° C. or less during increasing temperature of the decarburization annealed steel sheet in the finish annealing.

### TECHNICAL FIELD

The present invention relates to a manufacturing method of a grain oriented electrical steel sheet of which magnetic flux density is high, a grain oriented electrical steel sheet for a wound core, and a wound core.

### BACKGROUND ART

A grain oriented electrical steel sheet is a steel sheet containing Si for approximately 2 mass % to 5 mass %, of which orientations of crystal grains are highly integrated to a {110}<001> orientation, and it is used as a material of a wound core and so on of a stationary induction apparatus such as a transformer. A control of the orientation of the crystal grain is performed with a catastrophic grain growth phenomenon called as a secondary recrystallization.

The following two methods are cited as a method controlling the secondary recrystallization. As one method, a slab is heated at a temperature of 1280° C. or more to solid-solve fine precipitations called as inhibitors almost completely, and thereafter, a hot-rolling, a cold-rolling, an annealing, and so on are performed, to make the fine precipitations precipitate during the hot-rolling and the annealing. As the other method, the slab is heated at a temperature of less than 1280° C., and thereafter, the hot-rolling, the cold-rolling, a nitriding treatment, the annealing, and so on are performed, to make AlN precipitate as the inhibitor during the nitriding treatment.

A core loss of the grain oriented electrical steel sheet are suppressed into low level by enlarging, for example, a magnetic flux density and decreasing a hysteresis loss. Besides, the magnetic flux density are further increased by more highly integrating the orientations of the crystal grains into the {110}<001> orientation by enhancing a function of the inhibitor.

Besides, it is also possible to reduce an energy loss at the transformer by taking a structure of an iron core such as a wound core of the transformer into consideration when a material of the grain oriented electrical steel sheet is determined.

However, a grain oriented electrical steel sheet considering the structure of the wound core is not conventionally manufactured.

### Citation List

### Patent Literature

Patent Literature 1: Japanese Examined Patent Application Publication No. 40-15644

Patent Literature 2: Japanese Examined Patent Application Publication No. 51-13469

Patent Literature 3: Japanese Examined Patent Application Publication No. 62-45285

Patent Literature 4: Japanese Laid-open Patent Publication No. 2-77525

Patent Literature 5: Japanese Laid-open Patent Publication No. 06-184640

Patent Literature 6: Japanese Laid-open Patent Publication No. 06-207220

Patent Literature 7: Japanese Laid-open Patent Publication No. 10-273727

Patent Literature 8: Japanese Laid-open Patent Publication No. 2008-261013

Patent Literature 9: Japanese Laid-open Patent Publication No. 2005-23393

Patent Literature 10: Japanese Laid-open Patent Publication No. 2003-3215

Patent Literature 11: Japanese Laid-open Patent Publication No. 2008-1983

### SUMMARY OF THE INVENTION

### Technical Problem

An object of the present invention is to provide a manufacturing method of a grain oriented electrical steel sheet capable of obtaining high magnetic flux density, a grain oriented electrical steel sheet for a wound core, and a wound core.

### Solution to Problem

Under industrial production conditions, a finish annealing generating a secondary recrystallization is performed while making a steel sheet after a cold-rolling into a coil state. Besides, a wound core is constituted by winding a grain oriented electrical steel sheet in a coil state. Accordingly, it is conceivable that an area where crystal orientations are aligned can be widely secured by making a winding direction of the grain oriented electrical steel sheet the same as the coil in the finish annealing when the wound core is manufactured, if the crystal grains of the grain oriented electrical steel sheet are extending in a rolling direction.

Besides, the present inventors found that a function of the inhibitor is enhanced and the crystal grains after the secondary recrystallization become peculiar shapes extending in the rolling direction, if Te is added to the slab before the hot-rolling when the grain oriented electrical steel sheet is manufactured.

Further, the present inventors found that it is possible to stably obtain the crystal grain in an appropriate size in an industrial scale by properly setting conditions and so on of the annealing after the hot-rolling.

The present invention is made based on the above-stated knowledge, and a summary thereof is as described below.

A manufacturing method of a grain oriented electrical steel sheet according to a first aspect of the present invention includes: heating a slab containing C: 0.02 mass % to 0.10 mass %, Si: 2.5 mass % to 4.5 mass %, Mn: 0.01 mass % to 0.15 mass %, S: 0.001 mass % to 0.050 mass %, acid-soluble Al: 0.01 mass % to 0.05 mass %, N: 0.002 mass % to 0.015 mass %, and Te: 0.0005 mass % to 0.1000 mass %, and of which balance is composed of Fe and inevitable impurities to 1280° C. or more; performing a hot-rolling of the slab to obtain a hot-rolled steel sheet; performing an annealing of the hot-rolled steel sheet to obtain an annealed steel sheet; performing a cold-rolling of the annealed steel sheet to obtain a cold-rolled steel sheet; performing a decarburization annealing of the cold-rolled steel sheet to obtain a decarburization annealed steel sheet; coiling the decarburization annealed steel sheet in a coil state; and performing a finish annealing of the coil-state decarburization annealed steel sheet, wherein the cold-rolled steel sheet is heated to a temperature of 800° C. or more at a rate of 30° C./sec or more and 100° C./sec or less during increasing temperature of the cold-rolled steel sheet in the decarburization annealing or before the decarburization annealing, and the decarburization annealed steel sheet is heated at a rate of 20° C./h or less within a temperature range of 750° C. or more and 1150° C. or less during increasing temperature of the decarburization annealed steel sheet in the finish annealing.

A manufacturing method of a grain oriented electrical steel sheet according to a second aspect of the present invention, includes: heating a slab containing C: 0.02 mass % to 0.10 mass %, Si: 2.5 mass % to 4.5 mass %, Mn: 0.05 mass % to 0.50 mass %, acid-soluble Al: 0.010 mass % to 0.050 mass %, N: 0.001 mass % to 0.015 mass %, and Te: 0.0005 mass % to 0.1000 mass %, of which total content of S and Se is 0.02 mass % or less, and of which balance is composed of Fe and inevitable impurities at less than 1280° C.; performing a hot-rolling of the slab to obtain a hot-rolled steel sheet; performing an annealing of the hot-rolled steel sheet to obtain an annealed steel sheet; performing a cold-rolling of the annealed steel sheet to obtain a cold-rolled steel sheet; performing a decarburization annealing of the cold-rolled steel sheet to obtain a decarburization annealed steel sheet; coiling the decarburization annealed steel sheet in a coil state; performing a finish annealing of the coil-state decarburization annealed steel sheet; and further performing a nitridation annealing of the cold-rolled steel sheet or the decarburization annealed steel sheet, wherein the cold-rolled steel sheet is heated to a temperature of 800° C. or more at a rate of 30° C./sec or more and 100° C./sec or less during increasing temperature of the cold-rolled steel sheet in the decarburization annealing or before the decarburization annealing, and the decarburization annealed steel sheet is heated at a rate of 20° C./h or less within a temperature range of 750° C. or more and 1150° C. or less during increasing temperature of the decarburization annealed steel sheet in the finish annealing.

A grain oriented electrical steel sheet for a wound core according to a third aspect of the present invention, contains Si: 2.5 mass % to 4.5 mass % wherein the balance is composed of Fe and inevitable impurities, an average value of a shape ratio represented by “(a length in a rolling direction)/(a length in a width direction)” of a crystal grain is 2 or more; an average value of the lengths in the rolling direction of the crystal grains is 100 mm or more, and a value of a magnetic flux density when a magnetic field of 800 A/m is supplied at a frequency of 50 Hz is 1.94 T or more.

A wound core according to a fourth aspect of the present invention, includes the grain oriented electrical steel sheet.

### Advantageous Effects of Invention

According to the present invention, a shape of the crystal grain becomes one suitable for a wound core and a high magnetic flux density can be obtained because it is manufactured by passing through appropriate decarburization annealing and finish annealing.

### BRIEF DESCRIPTION OF DRAWINGS

FIG. 1 is a view representing a relationship of a temperature increasing rate in a decarburization annealing, a temperature increasing rate in a finish annealing, presence/absence of Te, and a magnetic flux density;

FIG. 2 is a schematic view illustrating a wound core manufactured with a first embodiment and a transformer using the wound core;

FIG. 3 is a flowchart illustrating a manufacturing method of a grain oriented electrical steel sheet according to a second embodiment; and

FIG. 4 is a flowchart illustrating a manufacturing method of a grain oriented electrical steel sheet according to a third embodiment.

### DESCRIPTION OF EMBODIMENTS

As stated above, the present inventors found that the crystal grains after the secondary recrystallization become peculiar shapes extending in the rolling direction if Te is added to the slab before the hot-rolling when the grain oriented electrical steel sheet is manufactured.

Besides, the present inventors also found that a degree of integration of the crystal grains to the {110}<001> orientation is extremely high in the grain oriented electrical steel sheet of which crystal grains are in the shape extending in the rolling direction, and magnetic properties of the grain oriented electrical steel sheet as stated above are good, and it is suitable for a wound core and a transformer using the wound core.

Here, it is conceivable that it is important to appropriately control a texture after a decarburization annealing to enough secure a length of the crystal grain after the secondary recrystallization in a rolling direction. Besides, it is estimated that a start temperature of the secondary recrystallization is high in the steel sheet to which Te is added compared to a steel sheet to which Te is not added, and there is a case when the secondary recrystallization becomes unstable resulting from the above. Accordingly, it is conceivable that it is important to appropriately control the temperature increasing rate in the finish annealing to stabilize the secondary recrystallization.

The inventors conduct the following experiments to establish a technology stably manufacturing particularly a grain oriented electrical steel sheet with high magnetic flux density suitable for a wound core and a transformer with the wound core by certainly obtaining an adding effect of Te based on the above-stated knowledge.

A slab (not containing Te) having a composition containing C: 0.08 mass %, Si: 3.26 mass %, Mn: 0.08 mass %, S: 0.026 mass %, acid-soluble Al: 0.03 mass %, and N: 0.008 mass %, and the balance is composed of Fe and inevitable impurities was manufactured in a vacuum melting furnace. Besides, a slab (containing Te) having a composition in which Te: 0.013 mass % was added to the above-stated composition was also manufactured. An annealing (slab heating) at 1350° C. for one hour, and thereafter, a hot-rolling of these slabs were performed to obtain a hot-rolled steel sheet.

Next, the annealing at 1100° C. for 120 seconds was performed for the hot-rolled steel sheets, and thereafter, acid pickling was performed. Subsequently, a cold-rolling of the hot-rolled steel sheet was performed, and thereby, a cold-rolled steel sheet of which thickness was 0.23 mm is obtained. Next, a decarburization annealing was performed for the cold-rolled steel sheet in the wet hydrogen atmosphere at 850° C. for 150 seconds, and thereby, a decarburization annealed steel sheet was obtained. In the decarburization annealing, a temperature increasing rate up to 800° C. was changed within a range of 10° C./sec to 1000° C./sec.

An annealing separating agent of which major constituent was MgO was coated on a surface of the decarburization annealed steel sheet by water slurry after the decarburization annealing, and thereafter, the secondary recrystallization was generated by performing a finish annealing at 1150° C. for 20 hours to obtain a finish annealed steel sheet. In the finish annealing, an average temperature increasing rate to less than 750° C. was set to be 50° C./h, and an average temperature increasing rate to 750° C. or more and 1150° C. or less was changed within a range of 10° C./h to 50° C./h. Besides, the finish annealing was performed under a state in which the decarburization annealed steel sheet was bent such that a radius of curvature was 750 mm. This is because the finish annealing is performed under the state in which the decarburization annealed steel sheet is made into the coil state under the industrial manufacturing conditions as stated above. A ceramic coating film is formed at a surface of the finish annealed steel sheet during the finish annealing.

Next, the finish annealed steel sheet was water washed, and thereafter, it was sheared into a single-plate magnetic measurement size. Subsequently, an insulating material of which major constituent is aluminum phosphate and colloidal silica was coated on the surface of the finish-annealed steel sheet, a baking thereof was performed, and thereby, an insulating film was formed. A sample of the grain oriented electrical steel sheet was obtained as stated above.

The magnetic flux density of each sample was measured. A value of the magnetic flux density (B8) when a magnetic field of 800 A/m was supplied at a frequency of 50 Hz was measured as the magnetic flux density. Besides, the insulating film was removed after the measurement of the magnetic flux density, and an area ratio of a region (secondary recrystallization poor part) made up of fine crystal grains called as fine grains of which grain diameter (circle-equivalent diameter) was less than 2 mm was measured. Further, a shape ratio C and a length D in a rolling direction of the crystal grain of each sample were measured. Here, the shape ratio C was set to be “(a length in the rolling direction)/(a length in a plate-width direction)”.

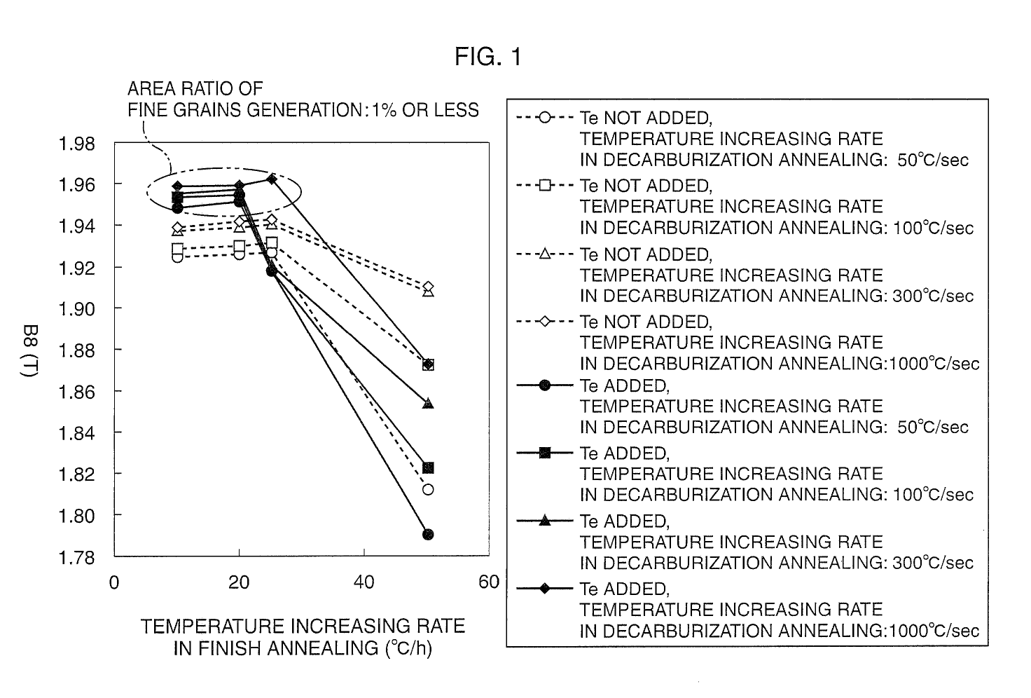

FIG. 1 represents a relationship of the temperature increasing rate in the decarburization annealing, the temperature increasing rate in the finish annealing, presence/absence of Te, and the magnetic flux density. In FIG. 1, a sample of which an area ratio of the region made up of the fine grains (secondary recrystallization poor part) was 1% or less is also represented. Here, the area ratio of that region is an area ratio of fine grains generation. As illustrated in FIG. 1, a large magnetic flux density was obtained in a sample obtained from a slab to which Te was added compared to a sample obtained from a slab to which Te was not added. In particular, the magnetic flux density was stably high such as 1.94 T or more and a fine grains generation area ratio was stably 1% or less in the sample of which the temperature increasing rate in the decarburization annealing was 30° C./sec or more and the temperature increasing rate in the finish annealing was 20° C./h or less.

Besides, an average value of the length D was large in the sample obtained from the slab to which Te was added. In particular, an average value Cave of the shape ratio C was 2 or more, and an average value Dave of the length D was 100 mm or more in the sample obtained from the slab to which Te was added, of which the temperature increasing rate in the decarburization annealing was 100° C./sec or less and the temperature increasing rate of the finish annealing was 20° C./h or less. Here, the average value Cave and the average value Dave were the average values of the lengths D and the shape ratios C of the crystal grains of which lengths D were 10 nm or more. This is because the crystal grain of which length D is 10 nm or more largely affects on properties of a transformer.

It turns out from results of the experiments as stated above that the magnetic flux density (B8) of 1.94 T or more is obtained, the average value Cave becomes 2 or more, and the average value Dave becomes 100 mm or more if the slab containing Te is used, it is heated to a temperature of 800° C. or more at the rate of 30° C./sec or more and 100° C./sec or less in the decarburization annealing and the temperature increasing rate from 750° C. or more and 1150° C. or less in the finish annealing is set to be 20° C./h or less. Namely, it is possible to manufacture a grain oriented electrical steel sheet suitable for a wound core and a transformer with the wound core by performing the processes based on the above-stated conditions.

### FIRST EMBODIMENT

Next, a first embodiment of the present invention is described. A grain oriented electrical steel sheet according to the first embodiment contains Si: 2.5 mass % to 4.5 mass % %, and the balance is composed of Fe and inevitable impurities. Besides, the average value Cave is 2 or more and the average value Dave is 100 mm or more as for the shape of the crystal grain. Further, the value of the magnetic flux density (B8) of the grain oriented electrical steel sheet is 1.94 T or more.

Si enhances electric resistance of the grain oriented electrical steel sheet, and reduces an eddy current loss constituting a part of core loss. When a content of Si is less than 2.5 mass %, an effect reducing the eddy current loss is insufficient. On the other hand, when the content of Si exceeds 4.5 mass %, processability of the grain oriented electrical steel sheet is low. Accordingly, the content of Si is set to be 2.5 mass % or more and 4.5 mass % or less.

Note that elements forming inhibitors in a manufacturing process of the grain oriented electrical steel sheet and remaining in the grain oriented electrical steel sheet after purifization resulting from a high-temperature annealing are also contained in the inevitable impurities.

When the average value Dave is 100 mm or more, particularly good magnetic properties can be obtained if the grain oriented electrical steel sheet is used for the wound core. However, when the average value Dave is less than 100 mm, a particularly large effect is not obtained if it is used for the wound core. Accordingly, the average value Dave is set to be 100 mm or more.

Besides, when the average value Cave is less than 2, a deviation angle of crystal orientation becomes easy to be large and enough magnetic properties is not obtained even if the average value Dave is 100 mm or more. Accordingly, the average value Cave is set to be 2 or more.

Besides, the enough magnetic properties cannot be obtained if the value of the magnetic flux density (B8) is less than 1.94 T. Accordingly, the value of the magnetic flux density (B8) is set to be 1.94 T or more.

In the grain oriented electrical steel sheet having the crystal grains as stated above, a degree of integration of the crystal grains to {110}<001> orientation is extremely high, and the good magnetic properties can be obtained. When a wound core is manufactured with the grain oriented electrical steel sheet as stated above, a winding direction of an iron core is defined to coincide with a winding direction of the coil in the finish annealing, and thereby, it becomes possible to widely secure an area where the crystal orientation is aligned. As a result, a transformer with high efficiency and having good properties can be obtained.

The shape ratio C and the length D may be measured as described below. A pit pattern reflecting the crystal orientation appears on a surface of a steel sheet when the acid pickling is performed after the insulating film and the ceramic film of the grain oriented electrical steel sheet are removed. The pit pattern is different when the crystal orientations are different because a degree of reflection of light is different. Accordingly, it is possible to recognize an interface between the crystal grains, namely, a grain boundary in a broad perspective. Next an image of the surface of the steel sheet is acquired with, for example, a commercially available image scanner, and this image is analyzed with, for example, commercially available image analysis software. As a result, it is possible to find the length D in the rolling direction and the length in the plate-width direction of each crystal grain. The shape ratio C is calculated by dividing the length D in the rolling direction by the length in the plate-width direction.

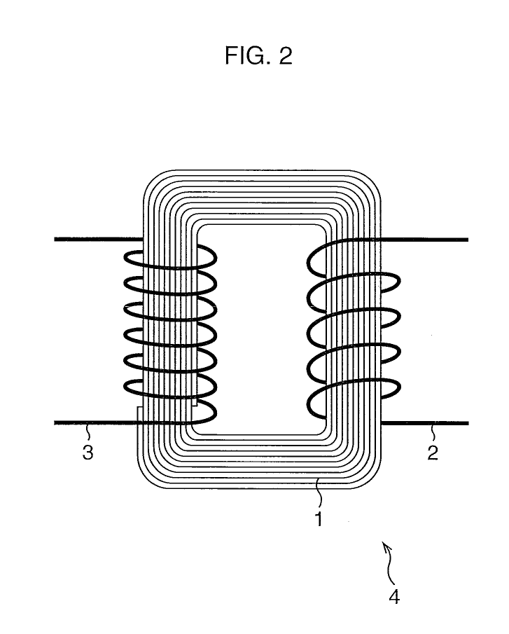

FIG. 2 is a schematic view illustrating a wound core manufactured with the first embodiment and a transformer with the wound core. As illustrated in FIG. 2, a wound core 4 is constituted by winding a piece of a grain oriented electrical steel sheet 1 in a coil state. Besides, two pieces of winding wires 2, 3 are attached to the wound core 4 to constitute a transformer. Note that a structure illustrated in FIG. 2 is an example of the present invention, and the present invention is not limited to this structure. For example, three or more pieces of winding wires may be attached to the wound core.

### SECOND EMBODIMENT

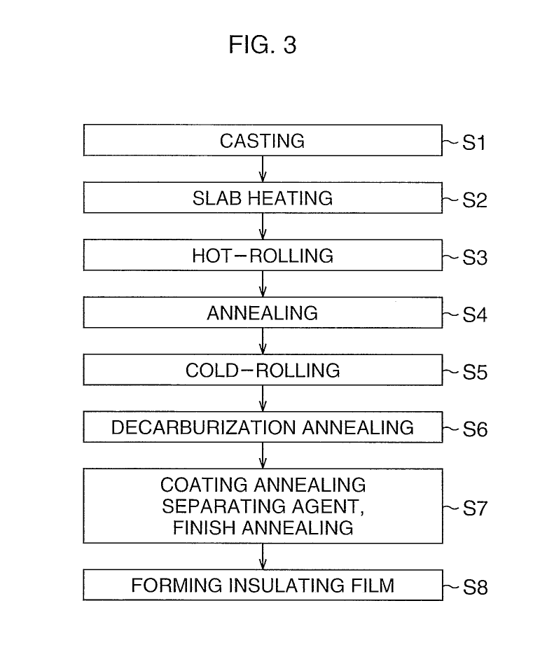

Next, a second embodiment of the present invention is described. In the second embodiment, the grain oriented electrical steel sheet as stated above is manufactured. FIG. 3 is a flowchart illustrating a manufacturing method of a grain oriented electrical steel sheet according to the second embodiment.

In the second embodiment, first, a slab is manufactured by performing casting of molten steel for a grain oriented electrical steel sheet (step S1). A casting method is not particularly limited. The molten steel contains, for example, C: 0.02 mass % to 0.10 mass %, Si: 2.5 mass % to 4.5 mass %, Mn: 0.01 mass % to 0.15 mass %, acid-soluble Al: 0.01 mass % to 0.05 mass %, N: 0.002 mass % to 0.015 mass %, and Te: 0.0005 mass % to 0.1000 mass %. The molten steel may further contain S, and furthermore contain Se. Incidentally, a total content of S and Se is 0.001 mass % to 0.050 mass %. Besides, the molten steel may further contain Bi: 0.0005 mass % to 0.1000 mass %. The balance of the molten steel is composed of Fe and inevitable impurities.

Here, reasons for numerical limitations of a composition of the molten steel are described.

C has various functions such as a function suppressing a growth of the crystal grains during a slab heating. When C content is less than 0.02 mass %, an effect owing to these functions is not fully obtained. For example, a crystal grain diameter after the slab heating becomes large, and the core loss becomes large. On the other hand, when the C content exceeds 0.10 mass %, it becomes necessary to perform a decarburization annealing after a cold-rolling for a long time, and a cost increases. Besides, decarburization may become incomplete, and a magnetization defect called as magnetic aging is easy to occur. Accordingly, the C content is set to be 0.02 mass % to 0.10 mass %. Besides, the C content is preferable to be 0.05 mass % or more, and preferable to be 0.09 mass % or less.

Si is an extremely effective element to enhance an electrical resistance of the grain oriented electrical steel sheet and to reduce the eddy current loss constituting a part of the core loss. When Si content is less than 2.5 mass %, the eddy current loss is not fully suppressed. On the other hand, when the Si content exceeds 4.5 mass %, the processability is low. Accordingly, the Si content is set to be 2.5 mass% to 4.5 mass %.

Mn is an important element forming MnS and/or MnSe being an inhibitor determining the secondary recrystallization. When Mn content is less than 0.01 mass %, enough amounts of MnS and MnSe is not formed. On the other hand, when the Mn content exceeds 0.15 mass %, it is difficult to solid-solve MnS and MnSe during the slab heating. Besides, precipitates of MnS and MnSe are easy to become coarse, and it may be difficult to control to be a size functioning as the inhibitors. Accordingly, the Mn content is set to be 0.01 mass % to 0.15 mass %.

S is an important element forming the inhibitor by reacting with Mn. When S content is less than 0.001 mass % or exceeds 0.050 mass %, the effect of the inhibitor is not fully obtained. Accordingly, the S content is set to be 0.001 mass % to 0.050 mass %.

Se is an important element forming the inhibitor by reacting with Mn, and may be contained together with S. However, when the total content of S and Se is less than 0.001 mass % or exceeds 0.050 mass %, the effect of the inhibitor is not fully obtained. Accordingly, the total content of S and Se is set to be 0.001 mass % to 0.050 mass %.

Acid-soluble Al is an important element forming AlN being the inhibitor. When acid-soluble

Al content is less than 0.01%, an enough amount of AlN is not formed, and inhibitor strength is insufficient. On the other hand, when the acid-soluble Al content exceeds 0.05%, AlN is coarse and the inhibitor strength is low. Accordingly, the acid-soluble Al content is set to be 0.01 mass % to 0.05 mass %.

N is an important element forming AlN by reacting with acid-soluble Al. When N content is less than 0.002 mass % or exceeds 0.015 mass %, the effect of the inhibitor is not fully obtained. Accordingly, the N content is set to be 0.002 mass % to 0.015 mass %. Besides, the N content is preferable to be 0.006 mass % or more.

Te is an important element enhancing the inhibitor and contributing to an improvement of the magnetic flux density. Besides, Te also has a function making the shape of the crystal grain into the one extending in the rolling direction. When Te content is less than 0.0005%, an effect owing to the above-stated functions is not fully obtained. On the other hand, when the Te content exceeds 0.1000 mass %, a rolling property is low. Accordingly, the Te content is set to be 0.0005 mass % to 0.1000 mass %.

When Bi is contained together with Te, the magnetic flux density is further improved. When Bi content is less than 0.0005%, an effect owing to this function is not fully obtained. On the other hand, when the Bi content exceeds 0.1000 mass %, the rolling property is low. Accordingly, when Bi is contained in the molten steel, the content thereof is set to be 0.0005 mass % to 0.1000 mass %.

Note that one kind or more element selected from a group consisting of Sn, Sb, Cu, Ag, As, Mo, Cr, P, Ni, B, Pb, V, Ge, and Ti may be contained as an element stabilizing the secondary recrystallization. However, when a total content of these elements is less than 0.0005%, an effect of the stabilization of the secondary recrystallization is not fully obtained. On the other hand, when the total content of these elements exceeds 1.0000 mass %, the effect is saturated, and only the cost increases. Accordingly, the total content of these elements is preferable to be 0.0005 mass % or more and 1.0000 mass % or less, when these elements are contained.

In the second embodiment, a slab is manufactured from the molten steel having the composition as stated above, and thereafter, the slab is heated to a temperature of 1280° C. or more (step S2). When the heating temperature at this time is set to be less than 1280° C., it is impossible to fully made the inhibitors such as MnS, MnSe, AlN into a solution. Accordingly, the temperature of the slab heating is set to be 1280° C. or more. Besides, it is preferable that the temperature of the slab heating is set to be 1450° C. or less from a point of view of protecting equipments.

Next, a hot-rolling of the slab is performed to thereby obtain a hot-rolled steel sheet (step S3). A thickness of the hot-rolled steel sheet is not particularly limited, and for example, it is set to be 1.8 mm to 3.5 mm.

After that, an annealing of the hot-rolled steel sheet is performed to thereby obtain an annealed steel sheet (step S4). Conditions of the annealing are not particularly limited, and for example, the annealing is performed at a temperature of 750° C. to 1200° C. for 30 seconds to 10 minutes. The magnetic properties improve by this annealing.

Subsequently, a cold-rolling of the annealed steel sheet is performed to thereby obtain a cold-rolled steel sheet (step S5). The cold-rolling may be performed only once, and plural times of cold-rolling may be performed while performing intermediate annealing therebetween. It is preferable that the intermediate annealing is performed, for example, at a temperature of 750° C. to 1200° C. for 30 seconds to 10 minutes. Besides, the plural times of cold-rolling may be performed without performing the intermediate annealing therebetween in which the temperature of the annealed steel sheet exceeds 600° C. In this case, the magnetic properties improve if the annealing at approximately 300° C. or less is performed between the cold-rolling.

Note that there is a possibility that uniform properties are difficult to be obtained if the cold-rolling is performed without performing the intermediate annealing as stated above. Besides, the uniform properties become easy to be obtained but there is a possibility in which the magnetic flux density becomes low when the plural times of cold-rolling are performed while performing the intermediate annealing therebetween. Accordingly, it is preferable that the number of times of the cold-rolling and the presence/absence of the intermediate annealing are determined in accordance with properties required for a finally obtained grain oriented electrical steel sheet and the cost.

Besides, a reduction of a finish cold-rolling is preferable to be set at 80% to 95% in either cases.

The decarburization annealing is performed for the cold-rolled steel sheet in a wet hydrogen-nitrogen atmosphere at 900° C. or less after the cold-rolling to thereby obtain a decarburization annealed steel sheet (step S6). The C content in the decarburization annealed steel sheet is set to be, for example, 20 ppm or less. Note that details of conditions of the decarburization annealing are described later.

Next, an annealing separating agent (powder) of which major constituent is MgO is coated on a surface of the decarburization annealed steel sheet, and the decarburization annealed steel sheet is wound in a coil state. A finish annealing in a batch type is performed for the coil-state decarburization annealed steel sheet to thereby obtain a coil-state finish annealed steel sheet (step S7). Note that details of conditions of the finish annealing are described later.

After that, unwinding of the coil-state finish annealed steel sheet, and removal of the annealing separating agent are performed. Subsequently, a slurry liquid of which major constituent is aluminum phosphate and colloidal silica is coated on a surface of the finish annealed steel sheet, this is baked to form an insulating film (step S8).

Thus, the grain oriented electrical steel sheet may be manufactured.

### THIRD EMBODIMENT

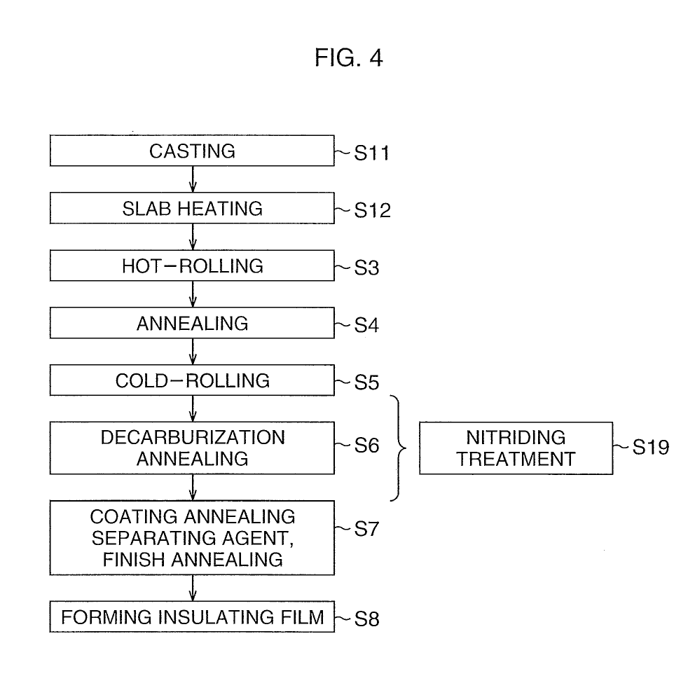

Next, a third embodiment of the present invention is described. The grain oriented electrical steel sheet as stated above is manufactured also in the third embodiment. FIG. 4 is a flowchart illustrating a manufacturing method of a grain oriented electrical steel sheet according to the third embodiment.

In the third embodiment, first, a slab is manufactured by performing casting of molten steel for a grain oriented electrical steel sheet (step S11). A casting method is not particularly limited. The molten steel contains, for example, C: 0.02 mass % to 0.10 mass %, Si: 2.5 mass % to 4.5 mass %, Mn: 0.05 mass % to 0.50 mass %, acid-soluble Al: 0.010 mass % to 0.050 mass %, N: 0.001 mass % to 0.015 mass %, and Te: 0.0005 mass % to 0.1000 mass %. The molten steel may further contain S, and furthermore contain Se. Incidentally, a total content of S and Se is 0.02 mass % or less. Besides, the molten steel may further contain Bi: 0.0005 mass % to 0.1000 mass %. The balance of the molten steel is composed of Fe and inevitable impurities.

Here, reasons for numerical limitations of a composition of the molten steel are described. In the third embodiment, (Al, Si)N is used as an inhibitor, which is different from the second embodiment. Accordingly, it is not necessary to precipitate MnS. The contents of Mn, S, and Se are therefore different from the second embodiment. The reasons for numerical limitations of the other elements are the same as the second embodiment.

In the third embodiment, Mn has functions to enhance a specific resistance and to reduce the core loss. Besides, Mn also has a function to suppress occurrences of cracks in the hot-rolling. When the Mn content is less than 0.05 mass %, effects owing to these functions is not fully obtained. On the other hand, when the Mn content exceeds 0.50 mass %, the magnetic flux density is low. Accordingly, the Mn content is set to be 0.05 mass % to 0.50 mass %.

In the third embodiment, S and Se adversely affect on the magnetic properties, and therefore, the total content of these is set to be 0.02 mass % or less.

In the third embodiment, a slab is manufactured from the molten steel having the composition as stated above, and thereafter, the slab is heated to a temperature of less than 1280° C. (step S12).

Next, the hot-rolling (step S3), the annealing (step S4), and the cold-rolling (step S5) are performed as same as the second embodiment.

After that, the decarburization annealing (step S6), the coating of the annealing separating agent and the finish annealing (step S7), and the forming of the insulating film (step S8) are performed as same as the second embodiment.

Note that in the third embodiment, a nitriding treatment of the steel sheet is performed to increase the N content of the steel sheet, and (Al, Si)N is formed as the inhibitor in the steel sheet (step S19) during a period from the completion of the cold-rolling (step S5) to the start of the coating of the annealing separating agent and the finish annealing (step S7). As the nitriding treatment, for example, an annealing in an atmosphere containing gas having nitriding ability (nitridation annealing) such as ammonia is performed. The nitriding treatment (step S19) may be performed either before or after the decarburization annealing (step S6). Besides, the nitriding treatment (step S19) may be performed simultaneously with the decarburization annealing (step S6).

Thus, the grain oriented electrical steel sheet may be manufactured.

(Conditions of Decarburization Annealing)

Next, the details of the conditions of the decarburization annealing in the second embodiment and the third embodiment are described.

In these embodiments, a temperature increasing rate in the decarburization annealing up to 800° C. is set to be 30° C./sec or more and 100° C./sec or less. As it is obvious from the above-stated experiments, the decarburization annealing is performed under the conditions as stated above, and thereby, the crystal grain of which average value Cave of the shape ratio C is 2 or more and average value Dave of the length D is 100 mm or more is obtained, and the grain oriented electrical steel sheet becomes the one suitable for the wound core and the transformer using the wound core.

When the temperature increasing rate up to 800° C. is less than 30° C./sec, the value of the magnetic flux density (B8) does not reach 1.94 T. When the temperature increasing rate up to 800° C. exceeds 100° C./sec, the average value Dave becomes less than 100 mm, and the grain oriented electrical steel sheet does not become the one suitable for the wound core and the transformer using the wound core.

Note that the heating as stated above may be performed before the decarburization annealing. For example, a heating furnace and a decarburization annealing furnace may be provided at different lines, or they may be provided at the same line as separated equipments. An atmosphere of this heating is not particularly limited. For example, the heating can be performed in a mixed atmosphere of nitrogen and hydrogen, a nitrogen atmosphere, a wet atmosphere, or a dry atmosphere, and in particular, it is preferable to perform the heating in the mixed atmosphere of nitrogen and hydrogen, or the nitrogen atmosphere. Besides, the atmosphere and the temperature after the heating to the start of the decarburization annealing are not particularly limited. It may let cool in the atmosphere, or be cooled to the room temperature.

Besides, a method controlling the temperature increasing rate is not particularly limited. For example, an electrical heater such as an induction heater or an ohmic heater may be provided at a previous stage of a decarburization annealing equipment using a radiant tube using normal radiant heat or an EREMA (electric resistance material) heating element.

(Conditions of Finish Annealing)

Next, the details of the conditions of the finish annealing in the second embodiment and the third embodiment are described.

In these embodiments, the steel sheet is heated in the mixed atmosphere of nitrogen and hydrogen, for example, to exhibit the secondary recrystallization at the finish annealing time. After that, the atmosphere is changed into the hydrogen atmosphere, and the steel sheet is held at an annealing temperature of 1100° C. to 1200° C. for approximately 20 hours. As a result, impurities such as N, S, and Se diffuse toward outside of the decarburization annealed steel sheet to be removed, and the magnetic properties become better. Besides, the crystal grains of the {110}<001> orientation are formed by the secondary recrystallization.

Further, in these embodiments, the temperature increasing rate within a temperature range of 750° C. or more and 1150° C. or less is set at 20° C./h or less in the finish annealing. The finish annealing is performed under the condition as stated above, and thereby, a behavior of the secondary recrystallization is stabilized as it is obvious from the above-stated experiments.

In the decarburization annealed steel sheet containing Te, a start temperature of the secondary recrystallization shifts toward a high temperature side compared to the decarburization annealed steel sheet which does not contain Te, and therefore, it is conceivable that the behavior of the secondary recrystallization becomes unstable, and the secondary recrystallization poor part made up of the fine grains is easy to be generated. On the other hand, in the second embodiment and the third embodiment, the temperature increasing rate is set to be the appropriate one based on the above-stated experimental results, and therefore, it is possible to stabilize the behavior of the secondary recrystallyzation. Note that a lower limit of the temperature increasing rate is not particularly limited, but it is preferable that the temperature increasing rate within the temperature range of 750° C. or more and 1150° C. or less is 3° C./h or more from a point of view of the annealing equipment and the industrial productivity.

Besides, it is preferable from a point of view of properties and productivity that the atmosphere at an initial stage of the finish annealing is set to be the mixed atmosphere of nitrogen and hydrogen as stated above. There is a tendency in which the secondary recrystallization is stabilized if a nitrogen partial pressure is increased, and there is a tendency in which the magnetic flux density improves but the secondary recrystallization is easy to be unstable if the nitrogen partial pressure is decreased.

Besides, a retention annealing may be performed in a middle of the heating of the finish annealing. If the retention annealing is performed, it is possible to improve adhesiveness of the insulating film (glass film) to a base material by decreasing moisture contained in the powder of MgO being the major constituent of the annealing separating agent.

### EXAMPLE

Next, experiments performed by the present inventors are described. Conditions and so on in these experiments are examples employed to verify practicality and effects of the present invention, and the present invention is not limited to these examples.

(First Experiment)

First, a slab containing components represented in Table 1 and the balance thereof was composed of Fe and inevitable impurities was manufactured with a vacuum melting furnace in a laboratory. Next, an annealing of the slab (slab heating) was performed at 1350° C. for one hour, and thereafter, a hot-rolling was performed to obtain a hot-rolled steel sheet.

TABLE 1

| | COMPONENT (MASS %) | | | | | | |
|---|---|---|---|---|---|---|---|
| | | | | | ACID-SOLUBLE | | |
| | C | Si | Mn | S | Al | N | Te |
| SLAB A | 0.08 | 3.25 | 0.08 | 0.026 | 0.03 | 0.008 | 0.000 |
| SLAB B | 0.08 | 3.23 | 0.08 | 0.025 | 0.03 | 0.008 | 0.007 |

Subsequently, an annealing of the hot-rolled steel sheet was performed at 1100° C. for 120 seconds to obtain an annealed steel sheet. Next, an acid pickling of the annealed steel sheet was performed, and thereafter, a cold-rolling of the annealed steel sheet was performed to obtain a cold-rolled steel sheet of which thickness was 0.23 mm. Subsequently, a decarburization annealing of the cold-rolled steel sheet was performed in a wet hydrogen atmosphere at 850° C. for 150 seconds to obtain a decarburization annealed steel sheet. A temperature increasing rate up to 800° C. was changed within a range of 10° C./sec to 1000° C./sec as represented in Table 2 in the decarburization annealing.

Next, an annealing separating agent of which major constituent was MgO was coated on a surface of the decarburization annealed steel sheet by water slurry. After that, a decarburization annealed steel sheet was bent such that a radius of curvature became 750 mm, and then a finish annealing was performed to obtain a finish annealed steel sheet. An average rate of heating from 750° C. or more to 1150° C. or less was changed within a range of 10° C./h to 50° C./h as represented in Table 2 in the finish annealing. Besides, an ultimate temperature of the finish annealing was set to be 1150° C., and an isothermal annealing was performed at 1150° C. for 20 hours.

Next, the finish annealed steel sheet was water washed, and thereafter, it was sheared in a single-plate magnetic measurement size. Subsequently, an insulating material of which major constituent was aluminum phosphate and colloidal silica was coated on the surface of the finish annealed steel sheet, and this was baked to form an insulating film. Thus, samples of the grain oriented electrical steel sheet were obtained. Note that 10 pieces of samples were manufactured by each condition.

The value of the magnetic flux density (B8) of each sample was measured. Besides, the insulating film and a ceramic film were removed and an area ratio R of a region made up of fine grains (secondary recrystallization poor part) was measured after the measurement of the magnetic flux density. Further, the shape ratio C and the length D in the rolling direction of the crystal grain of each sample were measured.

Note that the area ratio R, the shape ratio C, and the length D were measured by going through the following processes. Namely, first, the acid pickling was performed after the insulating film and the ceramic film were removed, and a grain boundary capable of being recognized in a broad perspective was traced with a permanent pen. Next, an image of a surface of the steel sheet was acquired with a commercially available image scanner, and this image was analyzed with commercially available image analysis software. Note that a measurement of the crystal grain diameter was necessary to specify the fine grain, and a circle-equivalent diameter was measured as the crystal grain diameter in this experiment.

An average value Rave of the area ratios R, an average value B8ave of the values of the magnetic flux densities (B8), an average value Cave' of the average values Cave of the shape ratios C, and an average value Dave' of the average values Dave of the lengths D were calculated by each condition. Further, a sample of which average value Rave was 1 or less, the average value B8ave was 1.940 T or more, the average value Cave' was 2 or more, and the average value Dave' was 100 mm was judged as good (◯), and the others were judged as not good (×). These results are represented in Table 2.

TABLE 2

| | | | TEMPERATURE | TEMPERATURE | | | | | |
|---|---|---|---|---|---|---|---|---|---|
| | | | INCREASING | INCREASING | | | | | |
| | | | RATE IN | RATE IN | | | | | |
| | | | DECARBURIZATION | FINISH | | | | | |
| | | | ANNEALING: | ANNEALING: | | B8ave | | Dave′ | |
| | No. | SLAB | (° C./sec) | (° C./sec) | Rave (%) | (T) | Cave′ | (mm) | EVALUATION |
| COMPARATIVE | A1 | A | 10 | 10 | 1 OR LESS | 1.923 | 1.29 | 43.3 | X |
| EXAMPLE | A2 | A | 10 | 20 | 1 OR LESS | 1.924 | 1.30 | 43.8 | X |
| | A3 | A | 10 | 25 | 1 OR LESS | 1.925 | 1.30 | 44.2 | X |
| | A4 | A | 10 | 50 | 20 | 1.788 | 1.32 | 44.6 | X |
| | A5 | A | 30 | 10 | 1 OR LESS | 1.924 | 1.28 | 40.7 | X |
| | A6 | A | 30 | 20 | 1 OR LESS | 1.924 | 1.29 | 40.9 | X |
| | A7 | A | 30 | 25 | 1 OR LESS | 1.925 | 1.30 | 41.1 | X |
| | A8 | A | 30 | 50 | 20 | 1.774 | 1.31 | 41.6 | X |
| | A9 | A | 50 | 10 | 1 OR LESS | 1.925 | 1.26 | 38.7 | X |
| | A10 | A | 50 | 20 | 1 OR LESS | 1.926 | 1.27 | 39.6 | X |
| | A11 | A | 50 | 25 | 1 OR LESS | 1.927 | 1.28 | 40.1 | X |
| | A12 | A | 50 | 50 | 15 | 1.812 | 1.28 | 41.2 | X |
| | A13 | A | 100 | 10 | 1 OR LESS | 1.928 | 1.23 | 35.1 | X |
| | A14 | A | 100 | 20 | 1 OR LESS | 1.930 | 1.24 | 35.7 | X |
| | A15 | A | 100 | 25 | 1 OR LESS | 1.932 | 1.26 | 36.3 | X |
| | A16 | A | 100 | 50 | 10 | 1.872 | 1.26 | 36.7 | X |
| | A17 | A | 300 | 10 | 1 OR LESS | 1.938 | 1.21 | 31.8 | X |
| | A18 | A | 300 | 20 | 1 OR LESS | 1.939 | 1.22 | 32.2 | X |
| | A19 | A | 300 | 25 | 1 OR LESS | 1.941 | 1.24 | 33.0 | X |
| | A20 | A | 300 | 50 | 5 | 1.908 | 1.25 | 33.5 | X |
| | A21 | A | 1000 | 10 | 1 OR LESS | 1.939 | 1.17 | 26.4 | X |
| | A22 | A | 1000 | 20 | 1 OR LESS | 1.942 | 1.18 | 27.1 | X |
| | A23 | A | 1000 | 25 | 1 OR LESS | 1.943 | 1.20 | 27.7 | X |
| | A24 | A | 1000 | 50 | 5 | 1.911 | 1.20 | 28.6 | X |
| | B1 | B | 10 | 10 | 5 | 1.890 | 2.79 | 153.7 | X |
| | B2 | B | 10 | 20 | 5 | 1.896 | 2.80 | 154.4 | X |
| | B3 | B | 10 | 25 | 10 | 1.865 | 2.81 | 154.9 | X |
| | B4 | B | 10 | 50 | 25 | 1.715 | 2.83 | 155.1 | X |
| EXAMPLE | B5 | B | 30 | 10 | 1 OR LESS | 1.945 | 2.75 | 145.3 | ◯ |
| | B6 | B | 30 | 20 | 1 OR LESS | 1.946 | 2.76 | 145.5 | ◯ |
| COMPARATIVE | B7 | B | 30 | 25 | 5 | 1.891 | 2.78 | 146.0 | X |
| EXAMPLE | B8 | B | 30 | 50 | 25 | 1.728 | 2.78 | 146.3 | X |
| EXAMPLE | B9 | B | 50 | 10 | 1 OR LESS | 1.948 | 2.59 | 137.2 | ◯ |
| | B10 | B | 50 | 20 | 1 OR LESS | 1.952 | 2.62 | 139.5 | ◯ |
| COMPARATIVE | B11 | B | 50 | 25 | 5 | 1.918 | 2.63 | 140.2 | X |
| EXAMPLE | B12 | B | 50 | 50 | 20 | 1.790 | 2.65 | 141.6 | X |
| EXAMPLE | B13 | B | 100 | 10 | 1 OR LESS | 1.953 | 2.46 | 107.2 | ◯ |
| | B14 | B | 100 | 20 | 1 OR LESS | 1.954 | 2.46 | 107.8 | ◯ |
| COMPARATIVE | B15 | B | 100 | 25 | 5 | 1.919 | 2.48 | 108.5 | X |
| EXAMPLE | B16 | B | 100 | 50 | 15 | 1.822 | 2.50 | 109.3 | X |
| | B17 | B | 300 | 10 | 1 OR LESS | 1.955 | 2.35 | 92.0 | X |
| | B18 | B | 300 | 20 | 1 OR LESS | 1.957 | 2.36 | 92.3 | X |
| | B19 | B | 300 | 25 | 5 | 1.921 | 2.38 | 93.1 | X |
| | B20 | B | 300 | 50 | 10 | 1.854 | 2.41 | 93.5 | X |
| | B21 | B | 1000 | 10 | 1 OR LESS | 1.959 | 2.31 | 72.8 | X |
| | B22 | B | 1000 | 20 | 1 OR LESS | 1.959 | 2.33 | 73.6 | X |
| | B23 | B | 1000 | 25 | 1 OR LESS | 1.962 | 2.35 | 73.9 | X |
| | B24 | B | 1000 | 50 | 10 | 1.873 | 2.35 | 74.5 | X |

As represented in Table 2, good results were obtained as for only six examples in which the slab B containing Te was used, the temperature increasing rate up to 800° C. was set to be 30° C./sec or more and 100° C./sec or less in the decarburization annealing, the average temperature increasing rate within the range of 750° C. to 1150° C. in the finish annealing was set to be 20° C./h or less. In these examples, the area ratio R was 1% or less.

(Second Experiment)

First, a slab containing components represented in Table 3 and the balance thereof was composed of Fe and inevitable impurities was manufactured with a vacuum melting furnace in a laboratory. Next, an annealing of the slab (slab heating) was performed at 1400° C. for one hour, and thereafter, a hot-rolling was performed to obtain a hot-rolled steel sheet.

TABLE 3

| | COMPONENT (MASS %) | | | | | | | |
|---|---|---|---|---|---|---|---|---|
| | | | | | | ACID-SOLUBLE | | |
| | C | Si | Mn | S | Se | Al | N | Te |
| SLAB C | 0.08 | 3.24 | 0.08 | 0.005 | 0.018 | 0.03 | 0.008 | 0.000 |
| SLAB D | 0.08 | 3.23 | 0.08 | 0.004 | 0.020 | 0.03 | 0.008 | 0.006 |

Subsequently, an annealing of the hot-rolled steel sheet was performed at 1000° C. for 100 seconds to obtain an annealed steel sheet. Next, an acid pickling of the annealed steel sheet was performed, and thereafter, a cold-rolling of the annealed steel sheet was performed to obtain a cold-rolled steel sheet of which thickness was 0.23 mm. In the cold-rolling, a rolling was performed until the thickness thereof became 1.7 mm, then the intermediate annealing was performed at 1050° C. for 100 seconds, and thereafter another rolling was performed until the thickness thereof becomes 0.23 mm. Subsequently, a decarburization annealing of the cold-rolled steel sheet was performed in a wet hydrogen atmosphere at 850° C. for 150 seconds to obtain a decarburization annealed steel sheet. A temperature increasing rate up to 800° C. was changed within a range of 10° C./sec to 1000° C./sec as represented in Table 4 in the decarburization annealing.

Next, the coating of the annealing separating agent, the finish annealing, and so on were performed as same as the first experiment, and the samples of the grain oriented electrical steel sheet were obtained. Note that 10 pieces of samples were manufactured by each condition similar to the first experiment.

The measurement and evaluation as same as the first experiment were performed. These results are represented in Table 4.

TABLE 4

| | | | TEMPERATEURE | TEMPERATEURE | | | | | |
|---|---|---|---|---|---|---|---|---|---|
| | | | INCREASING | INCREASING | | | | | |
| | | | RATE IN | RATE IN | | | | | |
| | | | DECARBURIZATION | FINISH | | | | | |
| | | | ANNEALING: | ANNEALING: | | B8ave | | Dave′ | |
| | No. | SLAB | (° C./sec) | (° C./sec) | Rave (%) | (T) | Cave′ | (mm) | EVALUATION |
| COMPARATIVE | C1 | C | 10 | 10 | 1 OR LESS | 1.921 | 1.35 | 46.9 | X |
| EXAMPLE | C2 | C | 10 | 20 | 1 OR LESS | 1.923 | 1.36 | 47.1 | X |
| | C3 | C | 10 | 25 | 1 OR LESS | 1.924 | 1.37 | 47.2 | X |
| | C4 | C | 10 | 50 | 20 | 1.755 | 1.39 | 47.5 | X |
| | C5 | C | 30 | 10 | 1 OR LESS | 1.925 | 1.31 | 44.3 | X |
| | C6 | C | 30 | 20 | 1 OR LESS | 1.926 | 1.32 | 44.6 | X |
| | C7 | C | 30 | 25 | 1 OR LESS | 1.927 | 1.32 | 44.8 | X |
| | C8 | C | 30 | 50 | 20 | 1.767 | 1.34 | 45.2 | X |
| | C9 | C | 50 | 10 | 1 OR LESS | 1.926 | 1.28 | 40.5 | X |
| | C10 | C | 50 | 20 | 1 OR LESS | 1.928 | 1.28 | 41.3 | X |
| | C11 | C | 50 | 25 | 1 OR LESS | 1.929 | 1.29 | 42.8 | X |
| | C12 | C | 50 | 50 | 20 | 1.771 | 1.30 | 43.2 | X |
| | C13 | C | 100 | 10 | 1 OR LESS | 1.930 | 1.25 | 37.9 | X |
| | C14 | C | 100 | 20 | 1 OR LESS | 1.931 | 1.26 | 38.3 | X |
| | C15 | C | 100 | 25 | 1 OR LESS | 1.933 | 1.28 | 38.9 | X |
| | C16 | C | 100 | 50 | 15 | 1.837 | 1.28 | 39.5 | X |
| | C17 | C | 300 | 10 | 1 OR LESS | 1.939 | 1.20 | 33.1 | X |
| | C18 | C | 300 | 20 | 1 OR LESS | 1.940 | 1.21 | 33.8 | X |
| | C19 | C | 300 | 25 | 1 OR LESS | 1.941 | 1.22 | 34.4 | X |
| | C20 | C | 300 | 50 | 5 | 1.910 | 1.24 | 35.3 | X |
| | C21 | C | 1000 | 10 | 1 OR LESS | 1.941 | 1.18 | 27.8 | X |
| | C22 | C | 1000 | 20 | 1 OR LESS | 1.942 | 1.19 | 28.3 | X |
| | C23 | C | 1000 | 25 | 1 OR LESS | 1.942 | 1.21 | 28.8 | X |
| | C24 | C | 1000 | 50 | 5 | 1.918 | 1.22 | 29.5 | X |
| | D1 | D | 10 | 10 | 5 | 1.893 | 2.85 | 157.6 | X |
| | D2 | D | 10 | 20 | 5 | 1.897 | 2.87 | 158.0 | X |
| | D3 | D | 10 | 25 | 10 | 1.863 | 2.88 | 158.3 | X |
| | D4 | D | 10 | 50 | 25 | 1.722 | 2.90 | 158.7 | X |
| EXAMPLE | D5 | D | 30 | 10 | 1 OR LESS | 1.946 | 2.79 | 150.9 | ◯ |
| | D6 | D | 30 | 20 | 1 OR LESS | 1.947 | 2.80 | 151.3 | ◯ |
| COMPARATIVE | D7 | D | 30 | 25 | 5 | 1.888 | 2.82 | 151.5 | X |
| EXAMPLE | D8 | D | 30 | 50 | 25 | 1.730 | 2.84 | 152.6 | X |
| EXAMPLE | D9 | D | 50 | 10 | 1 OR LESS | 1.949 | 2.60 | 140.0 | ◯ |
| | D10 | D | 50 | 20 | 1 OR LESS | 1.950 | 2.63 | 141.5 | ◯ |
| COMPARATIVE | D11 | D | 50 | 25 | 5 | 1.923 | 2.63 | 142.1 | X |
| EXAMPLE | D12 | D | 50 | 50 | 20 | 1.789 | 2.65 | 142.8 | X |
| EXAMPLE | D13 | D | 100 | 10 | 1 OR LESS | 1.952 | 2.48 | 110.2 | ◯ |
| | D14 | D | 100 | 20 | 1 OR LESS | 1.953 | 2.49 | 112.8 | ◯ |
| COMPARATIVE | D15 | D | 100 | 25 | 5 | 1.923 | 2.50 | 113.2 | X |
| EXAMPLE | D16 | D | 100 | 50 | 15 | 1.828 | 2.52 | 113.7 | X |
| | D17 | D | 300 | 10 | 1 OR LESS | 1.956 | 2.40 | 96.4 | X |
| | D18 | D | 300 | 20 | 1 OR LESS | 1.957 | 2.42 | 97.1 | X |
| | D19 | D | 300 | 25 | 5 | 1.925 | 2.43 | 97.5 | X |
| | D20 | D | 300 | 50 | 10 | 1.887 | 2.45 | 98.0 | X |
| | D21 | D | 1000 | 10 | 1 OR LESS | 1.958 | 2.35 | 73.3 | X |
| | D22 | D | 1000 | 20 | 1 OR LESS | 1.960 | 2.36 | 73.9 | X |
| | D23 | D | 1000 | 25 | 1 OR LESS | 1.962 | 2.38 | 74.4 | X |
| | D24 | D | 1000 | 50 | 10 | 1.896 | 2.38 | 74.9 | X |

As represented in Table 4, good results were obtained as for only six examples in which the slab B containing Te was used, the temperature increasing rate up to 800° C. was set to be 30° C./sec or more and 100° C./sec or less in the decarburization annealing, the average temperature increasing rate within the range of 750° C. to 1150° C. in the finish annealing was set to be 20° C./h or less. In these examples, the area ratio R was 1% or less.

(Third Experiment)

First, a slab containing components represented in Table 5 and the balance thereof was composed of Fe and inevitable impurities was manufactured with a vacuum melting furnace in a laboratory. Next, an annealing of the slab (slab heating) was performed at 1150° C. for one hour, and thereafter, a hot-rolling was performed to obtain a hot-rolled steel sheet.

TABLE 5

| | COMPONENT (MASS %) | | | | | | |
|---|---|---|---|---|---|---|---|
| | | | | | ACID-SOLUBLE | | |
| | C | Si | Mn | S | Al | N | Te |
| SLAB E | 0.08 | 3.27 | 0.10 | 0.007 | 0.03 | 0.010 | 0.000 |
| SLAB F | 0.08 | 3.26 | 0.11 | 0.009 | 0.03 | 0.009 | 0.011 |

Subsequently, an annealing of the hot-rolled steel sheet was performed at 1100° C. for 100 seconds to obtain an annealed steel sheet. Next, an acid pickling of the annealed steel sheet was performed, and thereafter, a cold-rolling of the annealed steel sheet was performed to obtain a cold-rolled steel sheet of which thickness was 0.23 mm. Subsequently, a decarburization annealing of the cold-rolled steel sheet was performed in a wet hydrogen atmosphere at 850° C. for 150 seconds to obtain a decarburization annealed steel sheet. A temperature increasing rate up to 800° C. was changed within a range of 10° C./sec to 1000° C./sec as represented in Table 6 and Table 7 in the decarburization annealing. Further, in the third experiment, a nitridation annealing was performed during the decarburization annealing or after the decarburization annealing as represented in Table 6 and Table 7.

Next, the coating of the annealing separating agent, the finish annealing, and so on were performed as same as the first experiment, and the samples of the grain oriented electrical steel sheet were obtained. Note that 10 pieces of samples were manufactured by each condition similar to the first experiment.

The measurement and evaluation as same as the first experiment were performed. These results are represented in Table 6 and Table 7.

TABLE 6

| | | | TEMPERATURE | | TEMPERATURE |
|---|---|---|---|---|---|
| | | | INCREASING | | INCREASING |
| | | | RATE IN | | RATE IN |
| | | | DECARBURIZATION | | FINISH |
| | | | ANNEALING: | PERFORMANCE TIMING OF | ANNEALING: |
| | No. | SLAB | (° C./sec) | NITRIDATION ANNEALING | (° C./sec) |
| COMPARATIVE | E1 | E | 10 | AFTER DECARBURIZATION ANNEALING | 10 |
| EXAMPLE | E2 | E | 10 | AFTER DECARBURIZATION ANNEALING | 20 |
| | E3 | E | 10 | AFTER DECARBURIZATION ANNEALING | 25 |
| | E4 | E | 10 | AFTER DECARBURIZATION ANNEALING | 50 |
| | E5 | E | 30 | AFTER DECARBURIZATION ANNEALING | 10 |
| | E6 | E | 30 | AFTER DECARBURIZATION ANNEALING | 20 |
| | E7 | E | 30 | AFTER DECARBURIZATION ANNEALING | 25 |
| | E8 | E | 30 | AFTER DECARBURIZATION ANNEALING | 50 |
| | E9 | E | 50 | AFTER DECARBURIZATION ANNEALING | 10 |
| | E10 | E | 50 | AFTER DECARBURIZATION ANNEALING | 20 |
| | E11 | E | 50 | AFTER DECARBURIZATION ANNEALING | 25 |
| | E12 | E | 50 | AFTER DECARBURIZATION ANNEALING | 50 |
| | E13 | E | 100 | AFTER DECARBURIZATION ANNEALING | 10 |
| | E14 | E | 100 | AFTER DECARBURIZATION ANNEALING | 20 |
| | E15 | E | 100 | AFTER DECARBURIZATION ANNEALING | 25 |
| | E16 | E | 100 | AFTER DECARBURIZATION ANNEALING | 50 |
| | E17 | E | 300 | AFTER DECARBURIZATION ANNEALING | 10 |
| | E18 | E | 300 | AFTER DECARBURIZATION ANNEALING | 20 |
| | E19 | E | 300 | AFTER DECARBURIZATION ANNEALING | 25 |
| | E20 | E | 300 | AFTER DECARBURIZATION ANNEALING | 50 |
| | E21 | E | 1000 | AFTER DECARBURIZATION ANNEALING | 10 |
| | E22 | E | 1000 | AFTER DECARBURIZATION ANNEALING | 20 |
| | E23 | E | 1000 | AFTER DECARBURIZATION ANNEALING | 25 |
| | E24 | E | 1000 | AFTER DECARBURIZATION ANNEALING | 50 |

| | | | B8ave | | Dave′ | |
|---|---|---|---|---|---|---|
| | No. | Rave (%) | (T) | Cave′ | (mm) | EVALUATION |
| COMPARATIVE | E1 | 1 OR LESS | 1.918 | 1.18 | 45.8 | X |
| EXAMPLE | E2 | 1 OR LESS | 1.919 | 1.20 | 46.2 | X |
| | E3 | 1 OR LESS | 1.921 | 1.21 | 46.5 | X |
| | E4 | 20 | 1.770 | 1.23 | 47.2 | X |
| | E5 | 1 OR LESS | 1.920 | 1.19 | 43.8 | X |
| | E6 | 1 OR LESS | 1.921 | 1.21 | 44.3 | X |
| | E7 | 1 OR LESS | 1.923 | 1.22 | 44.8 | X |
| | E8 | 20 | 1.784 | 1.24 | 45.7 | X |
| | E9 | 1 OR LESS | 1.923 | 1.20 | 40.0 | X |
| | E10 | 1 OR LESS | 1.924 | 1.23 | 40.8 | X |
| | E11 | 1 OR LESS | 1.925 | 1.24 | 41.5 | X |
| | E12 | 15 | 1.807 | 1.26 | 41.9 | X |
| | E13 | 1 OR LESS | 1.924 | 1.19 | 36.2 | X |
| | E14 | 1 OR LESS | 1.926 | 1.21 | 36.9 | X |
| | E15 | 1 OR LESS | 1.926 | 1.23 | 37.6 | X |
| | E16 | 10 | 1.851 | 1.25 | 37.9 | X |
| | E17 | 1 OR LESS | 1.934 | 1.18 | 33.3 | X |
| | E18 | 1 OR LESS | 1.936 | 1.19 | 33.8 | X |
| | E19 | 1 OR LESS | 1.937 | 1.20 | 34.1 | X |
| | E20 | 5 | 1.882 | 1.22 | 34.7 | X |
| | E21 | 1 OR LESS | 1.934 | 1.15 | 28.0 | X |
| | E22 | 1 OR LESS | 1.935 | 1.16 | 28.9 | X |
| | E23 | 1 OR LESS | 1.937 | 1.16 | 29.2 | X |
| | E24 | 5 | 1.901 | 1.17 | 30.0 | X |

TABLE 27

| | | | TEMPERATURE | | TEMPERATURE |
|---|---|---|---|---|---|
| | | | INCREASING | | INCREASING |
| | | | RATE IN | | RATE IN |
| | | | DECARBURIZATION | | FINISH |
| | | | ANNEALING: | PERFORMANCE TIMING OF | ANNEALING: |
| | No. | SLAB | (° C./sec) | NITRIDATION ANNEALING | (° C./sec) |
| COMPARATIVE | F1 | F | 10 | AFTER DECARBURIZATION ANNEALING | 10 |
| EXAMPLE | F2 | F | 10 | AFTER DECARBURIZATION ANNEALING | 20 |
| | F3 | F | 10 | AFTER DECARBURIZATION ANNEALING | 25 |
| | F4 | F | 10 | AFTER DECARBURIZATION ANNEALING | 50 |
| EXAMPLE | F5 | F | 30 | AFTER DECARBURIZATION ANNEALING | 10 |
| | F6 | F | 30 | AFTER DECARBURIZATION ANNEALING | 20 |
| COMPARATIVE | F7 | F | 30 | AFTER DECARBURIZATION ANNEALING | 25 |
| EXAMPLE | F8 | F | 30 | AFTER DECARBURIZATION ANNEALING | 50 |
| EXAMPLE | F9 | F | 50 | AFTER DECARBURIZATION ANNEALING | 10 |
| | F10 | F | 50 | AFTER DECARBURIZATION ANNEALING | 20 |
| COMPARATIVE | F11 | F | 50 | AFTER DECARBURIZATION ANNEALING | 25 |
| EXAMPLE | F12 | F | 50 | AFTER DECARBURIZATION ANNEALING | 50 |
| EXAMPLE | F13 | F | 100 | AFTER DECARBURIZATION ANNEALING | 10 |
| | F14 | F | 100 | AFTER DECARBURIZATION ANNEALING | 20 |
| COMPARATIVE | F15 | F | 100 | AFTER DECARBURIZATION ANNEALING | 25 |
| EXAMPLE | F16 | F | 100 | AFTER DECARBURIZATION ANNEALING | 50 |
| | F17 | F | 300 | AFTER DECARBURIZATION ANNEALING | 10 |
| | F18 | F | 300 | AFTER DECARBURIZATION ANNEALING | 20 |
| | F19 | F | 300 | AFTER DECARBURIZATION ANNEALING | 25 |
| | F20 | F | 300 | AFTER DECARBURIZATION ANNEALING | 50 |
| | F21 | F | 1000 | AFTER DECARBURIZATION ANNEALING | 10 |
| | F22 | F | 1000 | AFTER DECARBURIZATION ANNEALING | 20 |
| | F23 | F | 1000 | AFTER DECARBURIZATION ANNEALING | 25 |
| | F24 | F | 1000 | AFTER DECARBURIZATION ANNEALING | 50 |
| | F25 | F | 10 | DURING DECARBURIZATION ANNEALING | 10 |
| | F26 | F | 10 | DURING DECARBURIZATION ANNEALING | 20 |
| | F27 | F | 10 | DURING DECARBURIZATION ANNEALING | 25 |
| | F28 | F | 10 | DURING DECARBURIZATION ANNEALING | 50 |
| EXAMPLE | F29 | F | 30 | DURING DECARBURIZATION ANNEALING | 10 |
| | F30 | F | 30 | DURING DECARBURIZATION ANNEALING | 20 |
| COMPARATIVE | F31 | F | 30 | DURING DECARBURIZATION ANNEALING | 25 |
| EXAMPLE | F32 | F | 30 | DURING DECARBURIZATION ANNEALING | 50 |
| EXAMPLE | F33 | F | 50 | DURING DECARBURIZATION ANNEALING | 10 |
| | F34 | F | 50 | DURING DECARBURIZATION ANNEALING | 20 |
| COMPARATIVE | F35 | F | 50 | DURING DECARBURIZATION ANNEALING | 25 |
| EXAMPLE | F36 | F | 50 | DURING DECARBURIZATION ANNEALING | 50 |
| EXAMPLE | F37 | F | 100 | DURING DECARBURIZATION ANNEALING | 10 |
| | F38 | F | 100 | DURING DECARBURIZATION ANNEALING | 20 |
| COMPARATIVE | F39 | F | 100 | DURING DECARBURIZATION ANNEALING | 25 |
| EXAMPLE | F40 | F | 100 | DURING DECARBURIZATION ANNEALING | 50 |
| | F41 | F | 300 | DURING DECARBURIZATION ANNEALING | 10 |
| | F42 | F | 300 | DURING DECARBURIZATION ANNEALING | 20 |
| | F42 | F | 300 | DURING DECARBURIZATION ANNEALING | 25 |
| | F44 | F | 300 | DURING DECARBURIZATION ANNEALING | 50 |
| | F45 | F | 1000 | DURING DECARBURIZATION ANNEALING | 10 |
| | F46 | F | 1000 | DURING DECARBURIZATION ANNEALING | 20 |
| | F47 | F | 1000 | DURING DECARBURIZATION ANNEALING | 25 |
| | F48 | F | 1000 | DURING DECARBURIZATION ANNEALING | 50 |

| | | | B8ave | | Dave′ | |
|---|---|---|---|---|---|---|
| | No. | Rave (%) | (T) | Cave′ | (mm) | EVALUATION |
| COMPARATIVE | F1 | 5 | 1.883 | 2.55 | 163.8 | X |
| EXAMPLE | F2 | 5 | 1.889 | 2.57 | 164.1 | X |
| | F3 | 10 | 1.861 | 2.60 | 164.6 | X |
| | F4 | 25 | 1.703 | 2.65 | 165.0 | X |
| EXAMPLE | F5 | 1 OR LESS | 1.945 | 2.52 | 157.7 | ◯ |
| | F6 | 1 OR LESS | 1.948 | 2.54 | 158.2 | ◯ |
| COMPARATIVE | F7 | 5 | 1.890 | 2.57 | 158.8 | X |
| EXAMPLE | F8 | 25 | 1.721 | 2.59 | 159.4 | X |
| EXAMPLE | F9 | 1 OR LESS | 1.945 | 2.48 | 140.4 | ◯ |
| | F10 | 1 OR LESS | 1.947 | 2.50 | 141.2 | ◯ |
| COMPARATIVE | F11 | 5 | 1.890 | 2.51 | 141.9 | X |
| EXAMPLE | F12 | 20 | 1.787 | 2.52 | 142.7 | X |
| EXAMPLE | F13 | 1 OR LESS | 1.949 | 2.41 | 111.8 | ◯ |
| | F14 | 1 OR LESS | 1.950 | 2.43 | 112.5 | ◯ |
| COMPARATIVE | F15 | 5 | 1.910 | 2.45 | 113.1 | X |
| EXAMPLE | F16 | 15 | 1.807 | 2.46 | 113.6 | X |
| | F17 | 1 OR LESS | 1.954 | 2.33 | 95.0 | X |
| | F18 | 1 OR LESS | 1.955 | 2.33 | 95.8 | X |
| | F19 | 5 | 1.906 | 2.34 | 96.6 | X |
| | F20 | 10 | 1.875 | 2.35 | 96.9 | X |
| | F21 | 1 OR LESS | 1.956 | 2.25 | 75.5 | X |
| | F22 | 1 OR LESS | 1.957 | 2.27 | 76.1 | X |
| | F23 | 1 OR LESS | 1.959 | 2.28 | 76.7 | X |
| | F24 | 10 | 1.880 | 2.30 | 77.3 | X |
| | F25 | 5 | 1.878 | 2.56 | 160.2 | X |
| | F26 | 5 | 1.882 | 2.58 | 161.3 | X |
| | F27 | 10 | 1.856 | 2.62 | 161.6 | X |
| | F28 | 25 | 1.718 | 2.66 | 162.4 | X |
| EXAMPLE | F29 | 1 OR LESS | 1.943 | 2.54 | 155.2 | ◯ |
| | F30 | 1 OR LESS | 1.945 | 2.54 | 155.9 | ◯ |
| COMPARATIVE | F31 | 5 | 1.885 | 2.56 | 156.4 | X |
| EXAMPLE | F32 | 25 | 1.706 | 2.59 | 156.9 | X |
| EXAMPLE | F33 | 1 OR LESS | 1.942 | 2.47 | 139.2 | ◯ |
| | F34 | 1 OR LESS | 1.945 | 2.51 | 140.1 | ◯ |
| COMPARATIVE | F35 | 5 | 1.880 | 2.52 | 140.6 | X |
| EXAMPLE | F36 | 20 | 1.769 | 2.53 | 141.0 | X |
| EXAMPLE | F37 | 1 OR LESS | 1.948 | 2.42 | 112.6 | ◯ |
| | F38 | 1 OR LESS | 1.949 | 2.45 | 113.5 | ◯ |
| COMPARATIVE | F39 | 5 | 1.908 | 2.46 | 114.4 | X |
| EXAMPLE | F40 | 20 | 1.781 | 2.47 | 114.9 | X |
| | F41 | 1 OR LESS | 1.952 | 2.33 | 96.3 | X |
| | F42 | 1 OR LESS | 1.953 | 2.34 | 96.6 | X |
| | F43 | 5 | 1.911 | 2.36 | 97.1 | X |
| | F44 | 15 | 1.835 | 2.37 | 97.8 | X |
| | F45 | 1 OR LESS | 1.954 | 2.26 | 76.0 | X |
| | F46 | 1 OR LESS | 1.955 | 2.28 | 76.8 | X |
| | F47 | 1 OR LESS | 1.957 | 2.29 | 77.5 | X |
| | F48 | 10 | 1.876 | 2.32 | 78.3 | X |

As represented in Table 6 and Table 7, good results were obtained as for only six examples in which the slab B containing Te was used, the temperature increasing rate up to 800° C. was set to be 30° C./sec or more and 100° C./sec or less in the decarburization annealing, the average temperature increasing rate within the range of 750° C. to 1150° C. in the finish annealing was set to be 20° C./h or less. In these examples, the area ratio R was 1% or less.

(Fourth Experiment)

First, a slab containing components represented in Table 8 and the balance thereof was composed of Fe and inevitable impurities was manufactured with a vacuum melting furnace in a laboratory. Next, an annealing of the slab (slab heating) was performed at 1350° C. for one hour, and thereafter, a hot-rolling was performed to obtain a hot-rolled steel sheet.

TABLE 8

| | COMPONENT (MASS %) | | | | | | | |
|---|---|---|---|---|---|---|---|---|
| | | | | | ACID-SOLUBLE | | | |
| | C | Si | Mn | S | Al | N | Te | Bi |
| SLAB G | 0.08 | 3.25 | 0.09 | 0.025 | 0.03 | 0.010 | 0.000 | 0.005 |
| SLAB H | 0.08 | 3.25 | 0.08 | 0.023 | 0.03 | 0.009 | 0.007 | 0.006 |

Subsequently, an annealing of the hot-rolled steel sheet was performed at 1100° C. for 120 seconds to obtain an annealed steel sheet. Next, an acid pickling of the annealed steel sheet was performed, and thereafter, a cold-rolling of the annealed steel sheet was performed to obtain a cold-rolled steel sheet of which thickness was 0.23 mm. Subsequently, a decarburization annealing of the cold-rolled steel sheet was performed in a wet hydrogen atmosphere at 850° C. for 150 seconds to obtain a decarburization annealed steel sheet. A temperature increasing rate up to 800° C. was changed within a range of 10° C./sec to 1000° C./sec as represented in Table 9 in the decarburization annealing.

Next, the coating of the annealing separating agent, the finish annealing, and so on were performed as same as the first experiment, and the samples of the grain oriented electrical steel sheet were obtained. Note that 10 pieces of samples were manufactured by each condition similar to the first experiment.

The measurement and evaluation as same as the first experiment were performed. These results are represented in Table 9.

TABLE 9

| | | | TEMPERATURE | TEMPERATURE | | | | | |
|---|---|---|---|---|---|---|---|---|---|
| | | | INCREASING | INCREASING | | | | | |
| | | | RATE IN | RATE IN | | | | | |
| | | | DECARBURIZATION | FINISH | | | | | |
| | | | ANNEALING: | ANNEALING: | | B8ave | | Dave′ | |
| | No. | SLAB | (° C./sec) | (° C./sec) | Rave (%) | (T) | Cave′ | (mm) | EVALUATION |
| COMPARATIVE | G1 | G | 10 | 10 | 1 OR LESS | 1.935 | 1.59 | 76.3 | X |
| EXAMPLE | G2 | G | 10 | 20 | 1 OR LESS | 1.937 | 1.60 | 76.5 | X |
| | G3 | G | 10 | 25 | 5 | 1.906 | 1.62 | 77.0 | X |
| | G4 | G | 10 | 50 | 25 | 1.723 | 1.64 | 77.4 | X |
| | G5 | G | 30 | 10 | 1 OR LESS | 1.937 | 1.54 | 73.8 | X |
| | G6 | G | 30 | 20 | 1 OR LESS | 1.938 | 1.55 | 74.2 | X |
| | G7 | G | 30 | 25 | 5 | 1.893 | 1.58 | 74.5 | X |
| | G8 | G | 30 | 50 | 20 | 1.756 | 1.60 | 75.1 | X |
| | G9 | G | 50 | 10 | 1 OR LESS | 1.938 | 1.45 | 70.5 | X |
| | G10 | G | 50 | 20 | 1 OR LESS | 1.940 | 1.46 | 71.2 | X |
| | G11 | G | 50 | 25 | 5 | 1.905 | 1.48 | 71.8 | X |
| | G12 | G | 50 | 50 | 20 | 1.780 | 1.50 | 72.5 | X |
| | G13 | G | 100 | 10 | 1 OR LESS | 1.940 | 1.42 | 62.8 | X |
| | G14 | G | 100 | 20 | 1 OR LESS | 1.942 | 1.43 | 63.4 | X |
| | G15 | G | 100 | 25 | 5 | 1.913 | 1.44 | 63.8 | X |
| | G16 | G | 100 | 50 | 15 | 1.844 | 1.45 | 60.4 | X |
| | G17 | G | 300 | 10 | 1 OR LESS | 1.942 | 1.35 | 58.5 | X |
| | G18 | G | 300 | 20 | 1 OR LESS | 1.943 | 1.37 | 59.1 | X |
| | G19 | G | 300 | 25 | 1 OR LESS | 1.945 | 1.39 | 59.6 | X |
| | G20 | G | 300 | 50 | 5 | 1.911 | 1.40 | 59.9 | X |
| | G21 | G | 1000 | 10 | 1 OR LESS | 1.945 | 1.30 | 45.5 | X |
| | G22 | G | 1000 | 20 | 1 OR LESS | 1.946 | 1.32 | 45.9 | X |
| | G23 | G | 1000 | 25 | 1 OR LESS | 1.948 | 1.33 | 46.3 | X |
| | G24 | G | 1000 | 50 | 5 | 1.917 | 1.35 | 46.7 | X |
| | H1 | H | 10 | 10 | 5 | 1.900 | 2.50 | 160.2 | X |
| | H2 | H | 10 | 20 | 5 | 1.905 | 2.53 | 160.8 | X |
| | H3 | H | 10 | 25 | 10 | 1.877 | 2.54 | 161.5 | X |
| | H4 | H | 10 | 50 | 25 | 1.713 | 2.59 | 162.0 | X |
| EXAMPLE | H5 | H | 30 | 10 | 1 OR LESS | 1.949 | 2.44 | 154.4 | ◯ |
| | H6 | H | 30 | 20 | 1 OR LESS | 1.950 | 2.46 | 154.9 | ◯ |
| COMPARATIVE | H7 | H | 30 | 25 | 5 | 1.882 | 2.49 | 155.5 | X |
| EXAMPLE | H8 | H | 30 | 50 | 25 | 1.721 | 2.52 | 155.7 | X |
| EXAMPLE | H9 | H | 50 | 10 | 1 OR LESS | 1.950 | 2.38 | 145.3 | ◯ |
| | H10 | H | 50 | 20 | 1 OR LESS | 1.951 | 2.40 | 146.0 | ◯ |
| COMPARATIVE | H11 | H | 50 | 25 | 5 | 1.912 | 2.42 | 146.8 | X |
| EXAMPLE | H12 | H | 50 | 50 | 20 | 1.798 | 2.43 | 147.3 | X |
| EXAMPLE | H13 | H | 100 | 10 | 1 OR LESS | 1.955 | 2.35 | 110.5 | ◯ |
| | H14 | H | 100 | 20 | 1 OR LESS | 1.956 | 2.36 | 111.8 | ◯ |
| COMPARATIVE | H15 | H | 100 | 25 | 5 | 1.910 | 2.38 | 112.3 | X |
| EXAMPLE | H16 | H | 100 | 50 | 15 | 1.838 | 2.40 | 112.9 | X |
| | H17 | H | 300 | 10 | 1 OR LESS | 1.957 | 2.31 | 96.5 | X |
| | H18 | H | 300 | 20 | 1 OR LESS | 1.956 | 2.33 | 97.1 | X |
| | H19 | H | 300 | 25 | 5 | 1.915 | 2.34 | 97.6 | X |
| | H20 | H | 300 | 50 | 10 | 1.863 | 2.35 | 97.9 | X |
| | H21 | H | 1000 | 10 | 1 OR LESS | 1.960 | 2.25 | 76.7 | X |
| | H22 | H | 1000 | 20 | 1 OR LESS | 1.961 | 2.27 | 77.5 | X |
| | H23 | H | 1000 | 25 | 1 OR LESS | 1.963 | 2.28 | 78.2 | X |
| | H24 | H | 1000 | 50 | 10 | 1.885 | 2.29 | 78.9 | X |

As represented in Table 9, good results were obtained as for only six examples in which the slab B containing Te was used, the temperature increasing rate up to 800° C. was set to be 30° C./sec or more and 100° C./sec or less in the decarburization annealing, the average temperature increasing rate within the range of 750° C. to 1150° C. in the finish annealing was set to be 20° C./h or less. In these examples, the area ratio R was 1% or less.

### INDUSTRIAL APPLICABILITY

The present invention may be used in, for example, electrical steel sheet manufacturing industries and electrical steel sheet using industries.

1. A manufacturing method of a grain oriented electrical steel sheet, comprising:
heating a slab containing C: 0.02 mass % to 0.10 mass %, Si: 2.5 mass % to 4.5 mass %, Mn: 0.01 mass % to 0.15 mass %, S: 0.001 mass % to 0.050 mass %, acid-soluble Al: 0.01 mass % to 0.05 mass %, N: 0.002 mass % to 0.015 mass %, and Te: 0.0005 mass % to 0.1000 mass %, and of which balance is composed of Fe and inevitable impurities to 1280° C. or more;
performing a hot-rolling of the slab to obtain a hot-rolled steel sheet;
performing an annealing of the hot-rolled steel sheet to obtain an annealed steel sheet;
performing a cold-rolling of the annealed steel sheet to obtain a cold-rolled steel sheet;
performing a decarburization annealing of the cold-rolled steel sheet to obtain a decarburization annealed steel sheet;
coiling the decarburization annealed steel sheet in a coil state; and
performing a finish annealing of the coil-state decarburization annealed steel sheet, wherein
the cold-rolled steel sheet is heated to a temperature of 800° C. or more at a rate of 30° C./sec or more and 100° C./sec or less during increasing temperature of the cold-rolled steel sheet in the decarburization annealing or before the decarburization annealing, and
the decarburization annealed steel sheet is heated at a rate of 20° C./h or less within a temperature range of 750° C. or more and 1150° C. or less during increasing temperature of the decarburization annealed steel sheet in the finish annealing.

2. The manufacturing method of a grain oriented electrical steel sheet according to claim 1, wherein
the slab further contains Se, and
a total content of S and Se is 0.001 mass % to 0.050 mass %.

3. A manufacturing method of a grain oriented electrical steel sheet, comprising:
heating a slab containing C: 0.02 mass % to 0.10 mass %, Si: 2.5 mass % to 4.5 mass %, Mn: 0.05 mass % to 0.50 mass %, acid-soluble Al: 0.010 mass % to 0.050 mass %, N: 0.001 mass % to 0.015 mass %, and Te: 0.0005 mass % to 0.1000 mass %, of which total content of S and Se is 0.02 mass % or less, and of which balance is composed of Fe and inevitable impurities at less than 1280° C.;
performing a hot-rolling of the slab to obtain a hot-rolled steel sheet;
performing an annealing of the hot-rolled steel sheet to obtain an annealed steel sheet;
performing a cold-rolling of the annealed steel sheet to obtain a cold-rolled steel sheet;
performing a decarburization annealing of the cold-rolled steel sheet to obtain a decarburization annealed steel sheet;
coiling the decarburization annealed steel sheet in a coil state;
performing a finish annealing of the coil-state decarburization annealed steel sheet; and
further performing a nitridation annealing of the cold-rolled steel sheet or the decarburization annealed steel sheet, wherein
the cold-rolled steel sheet is heated to a temperature of 800° C. or more at a rate of 30° C./sec or more and 100° C./sec or less during increasing temperature of the cold-rolled steel sheet in the decarburization annealing or before the decarburization annealing, and
the decarburization annealed steel sheet is heated at a rate of 20° C./h or less within a temperature range of 750° C. or more and 1150° C. or less during increasing temperature of the decarburization annealed steel sheet in the finish annealing.

4. The manufacturing method of a grain oriented electrical steel sheet according to claim 1, wherein the slab further contains Bi: 0.0005 mass % to 0.1000 mass %.

5. The manufacturing method of a grain oriented electrical steel sheet according to claim 2, wherein the slab further contains Bi: 0.0005 mass % to 0.1000 mass %.

6. The manufacturing method of a grain oriented electrical steel sheet according to claim 3, wherein the slab further contains Bi: 0.0005 mass % to 0.1000 mass %.

7. A grain oriented electrical steel sheet for a wound core containing:
Si: 2.5 mass % to 4.5 mass %, wherein
the balance is composed of Fe and inevitable impurities,
an average value of a shape ratio represented by “(a length in a rolling direction)/(a length in a width direction)” of a crystal grain is 2 or more,
an average value of the lengths in the rolling direction of the crystal grains is 100 mm or more, and
a value of a magnetic flux density when a magnetic field of 800 A/m is supplied at a frequency of 50 Hz is 1.94 T or more.

8. The grain oriented electrical steel sheet for a wound core according to claim 7, wherein an area ratio of a region made up of crystal grains of which circle-equivalent diameters are less than 2 mm is 1% or less.

9. A wound core comprising:
a grain oriented electrical steel sheet, wherein
the grain oriented electrical steel sheet containing Si: 2.5 mass % to 4.5 mass %, and the balance is composed of Fe and inevitable impurities;
an average value of a shape ratio represented by “(a length in a rolling direction)/(a length in a width direction)” of a crystal grain is 2 or more,
an average value of the lengths in the rolling direction of the crystal grains is 100 mm or more, and
a value of a magnetic flux density when a magnetic field of 800 A/m is supplied at a frequency of 50 Hz is 1.94 T or more.

10. The wound core according to claim 9, wherein an area ratio of a region made up of crystal grains of which circle-equivalent diameters are less than 2 mm is 1% or less in the grain oriented electrical steel sheet.
